(19) United States
(12) Patent Application Publication
(10) Pub. No.: US 2024/0375101 A1
(43) Pub. Date: Nov. 14, 2024

(54) INTEGRATED MICROFLUIDIC SYSTEM FOR MONITORING A SAMPLE OVER A DIGESTION PROCESS

(71) Applicant: Kino Discovery, Inc., IRVINE, CA (US)

(72) Inventors: Jered Haun, Irvine, CA (US); David Kobayashi, Oxnard, CA (US); Marzieh Aliaghaei, Rancho Santa Margarita, CA (US); Philip Jian, San Diego, CA (US)

(21) Appl. No.: 18/659,613

(22) Filed: May 9, 2024

Related U.S. Application Data
(60) Provisional application No. 63/501,076, filed on May 9, 2023.

(51) Int. Cl. B01L 3/00; G06T 7/00

(52) U.S. Cl. CPC B01L 3/502715; G06T 7/0012; B01L 2200/14; B01L 2200/16; B01L 2300/0627; B01L 2300/088; B01L 2300/18; G06T 2207/30024

(57) ABSTRACT

A microfluidic system for processing a tissue sample. The system may comprise a microfluidic digestion device comprising an outlet. The system may further comprise a camera visually coupled to an interior of the microfluidic digestion device, configured to generate a stream of data comprising visual data of the tissue sample within the interior of the microfluidic digestion device. The system may further comprise a computing device configured to accept the stream of data from the camera as a plurality of images, and calculating an intensity of a red value of the tissue sample. The system may further comprise a microfluidic disaggregation device comprising an inlet fluidly coupled to the outlet of the microfluidic digestion device, an outlet, and a collection chamber fluidly coupled to the outlet of the microfluidic disaggregation device.

### CROSS-REFERENCES TO RELATED APPLICATIONS

This application is a non-provisional and claims benefit of U.S. Provisional Application No. 63/501,076, filed May 9, 2023, the specification of which is incorporated herein in its entirety by reference

### STATEMENT REGARDING FEDERALLY SPONSORED RESEARCH OR DEVELOPMENT

This invention was made with government support under Grant No. R43CA272118 awarded by National Cancer Institute. The government has certain rights in the invention.

### FIELD OF THE INVENTION

The present invention is directed to microfluidic systems for digestion, monitoring, and disaggregation of a tissue sample.

### BACKGROUND OF THE INVENTION

Tissues are highly complex ecosystems containing a diverse array of cell subtypes. Significant variation can also arise within a given subtype due to differences in activation state, genetic mutations, epigenetic distinctions, stochastic events, and microenvironmental factors. This has led to rapid growth in studies attempting to capture cellular heterogeneity, and thereby gain a better understanding of tissue and organ development, normal function, and disease pathogenesis. For example, in the context of cancer, intratumor heterogeneity is a key indicator of disease progression, metastasis, and the development of drug resistance. High-throughput single-cell analysis methods such as flow cytometry, mass cytometry, and single-cell RNA sequencing (scRNA-seq) are ideal for comprehensively identifying single cells based on molecular information, and these methods have already begun to transform the understanding of complex tissues by enabling the identification of previously unknown cell types and states.

However, a critical barrier to these efforts is the need to first process tissues into a suspension of single cells. Current methods involve mincing, digestion, disaggregation, and filtering that are labor-intensive, time-consuming, inefficient, and highly variable. Thus, new approaches and technologies are critically needed to ensure the reliability and widespread adoption of single-cell analysis methods for tissues. This would be particularly important for translating single-cell diagnostics to human specimens in clinical settings. Moreover, improved tissue dissociation would make it faster and easier to extract primary cells for ex vivo drug screening, engineered tissue constructs, and stem/progenitor cell therapies. Patient-derived organ-on-a-chip models, which seek to recapitulate complex native tissues for personalized drug testing, are a particularly exciting future direction that could be enabled by improved tissue dissociation.

scRNA-seq has recently emerged as a powerful and widely adaptable analysis technique that provides the full transcriptome of individual cells. This has enabled comprehensive cell reference maps, or atlases, to be generated for normal and diseased tissues, as well as the identification of previously unknown cell subtypes or functional states. For example, an atlas recently generated for normal murine kidneys uncovered a new collecting duct cell with a transitional phenotype and unexpected level of cellular plasticity. Moreover, an atlas of primary human breast epithelium linked distinct epithelial cell populations to known breast cancer subtypes, suggesting that these subtypes may develop from different cells of origin. For melanoma, scRNA-seq was used to identify three transcriptionally distinct states, one of which was drug-sensitive, and further demonstrated that drug resistance could be delayed using computationally optimized therapy schedules. While scRNA-seq is a powerful diagnostic modality, the mechanical process of breaking down the tissue into single cells can introduce confounding factors that may negatively influence data quality and reliability. One factor is the lack of standardization, which can lead to substantial variation across different research groups and tissue types. Another significant concern is that incomplete breakdowns could bias results towards cell types that are easier to liberate. A recent study utilizing single nuclei RNA sequencing (snRNA-seq) with murine kidney samples found that endothelial cells and mesangial cells were underrepresented in scRNA-seq data. Finally, lengthy enzymatic digestion times have been shown to alter transcriptomic signatures and generate stress responses that interfere with cell classification. Addressing these concerns would help propel the exciting field of scRNA-seq into the future for tissue aliasing and disease diagnostics.

Microfluidic technologies have advanced the fields of biology and medicine by miniaturizing devices to the scale of cellular samples and enabling precise sample manipulation. Most of this work has focused on manipulating and analyzing single cells. Only a small number of studies have addressed tissue processing, and even fewer have focused on breaking down tissue into smaller constituents. For example, microfluidic devices have been developed that specifically focused on breaking down cellular aggregates into single cells. This dissociation device contained a network of branching channels that progressively decreased in size down to −100 pm and contained repeated expansions and constrictions to break down aggregates using shear forces. Details regarding such devices may be found in Qiu, X. et al., Microfluidic device for mechanical dissociation of cancer cell aggregates into single cells, Lab Chip 15, 339-350 (2015) and Qiu, X. et al., Microfluidic channel optimization to improve hydrodynamic dissociation of cell aggregates and tissue, Nat. Sci. Reports 8, 2774 (2018).

Devices have been developed to this end, but tend to be unwieldy and create difficulties in actually monitoring characteristics of the tissue sample throughout the process. The lack of information able to be easily acquired from these devices creates difficulties in knowing when to allow the method to progress from digestion to disaggregation. Thus, there exists a present need for a microfluidic system that allows for the digestion and disaggregation of a tissue sample with monitoring capabilities for the efficient function of the system.

### BRIEF SUMMARY OF THE INVENTION

It is an objective of the present invention to provide systems and methods for digestion, monitoring, and disaggregation of a tissue sample, as specified in the independent claims. Embodiments of the invention are given in the dependent claims. Embodiments of the present invention can be freely combined if they are not mutually exclusive.

The present invention features a microfluidic system for processing a tissue sample. The system may comprise a microfluidic digestion device comprising an outlet, and a flow loop comprising a tissue chamber configured to hold the tissue sample. The system may further comprise a camera visually coupled to an interior of the microfluidic digestion device, configured to generate a stream of data comprising visual data of the tissue sample within the interior of the microfluidic digestion device. The system may further comprise a computing device communicatively coupled to the camera, comprising a processor capable of executing computer-readable instructions, and a memory component operatively coupled to the processor comprising computer-readable instructions for accepting the stream of data from the camera as a plurality of images and calculating, for each image of the plurality of images, an intensity of a red value of the tissue sample. The system may further comprise a microfluidic disaggregation device comprising an inlet fluidly coupled to the outlet of the microfluidic digestion device, an outlet, and a flow loop defined between the inlet of the microfluidic disaggregation device and the outlet of the microfluidic disaggregation device, and a collection chamber fluidly coupled to the outlet of the microfluidic disaggregation device.

The present invention features a method of using the microfluidic system. The method may comprise loading the tissue sample into the tissue chamber of the microfluidic digestion device, pumping the enzyme-containing fluid into the enzyme inlet of the microfluidic digestion device with the first pump, analyzing, by the camera, a state of the tissue sample within the microfluidic digestion device, transferring fluid containing processed tissue sample to the microfluidic disaggregation device, pumping the processed tissue sample from the microfluidic digestion device into the microfluidic disaggregation device with the second pump, and collecting effluent from the single cell aggregate outlet of the microfluidic disaggregation device in the collection chamber. In some embodiments, pumping the enzyme-containing fluid into the enzyme outlet of the microfluidic digestion device with the first pump comprises recirculating fluid into the microfluidic digestion device with the first pump through the enzyme inlet and the enzyme outlet.

One of the unique and inventive technical features of the present invention is the implementation of the camera in a microfluidic digestion system for identifying tissue area and color. Without wishing to limit the invention to any theory or mechanism, it is believed that the technical feature of the present invention advantageously provides for the efficient function of a microfluidic digestion and disaggregation device while allowing for constant monitoring of the tissue sample over the digestion process. None of the presently known prior references or work has the unique inventive technical feature of the present invention.

Furthermore, the inventive technical features of the present invention contributed to a surprising result. For example, the red color value intensity in tissue samples doesn't have a linear decline with time and is also interconnected with tissue swelling. Thus, one of ordinary skill in art would not expect it to be advantageous to use red color intensity as an indicator of tissue digestion progress. The present invention uses an algorithm based on combination of red color intensity and tissue size to monitor tissue digestion, which surprisingly allows for red color intensity to be used as a useful indicator of tissue digestion progress. Thus, the feature of the presently claimed invention contributed to a surprising result.

Any feature or combination of features described herein are included within the scope of the present invention provided that the features included in any such combination are not mutually inconsistent as will be apparent from the context, this specification, and the knowledge of one of ordinary skills in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a schematic diagram of the microfluidic system of the present invention.

FIG. 2 shows a flow chart of a method for using the microfluidic system of the present invention.

### DETAILED DESCRIPTION OF THE INVENTION

Following is a list of elements corresponding to a particular element referred to herein:
100 microfluidic system
110 microfluidic digestion device
112 enzyme outlet
114 enzyme inlet
116 cell aggregate outlet
120 camera
130 computing device
140 first pump
150 microfluidic disaggregation device
152 cell aggregate inlet
154 buffer inlet
156 buffer outlet
158 cell aggregate outlet
160 second pump
170 collection chamber

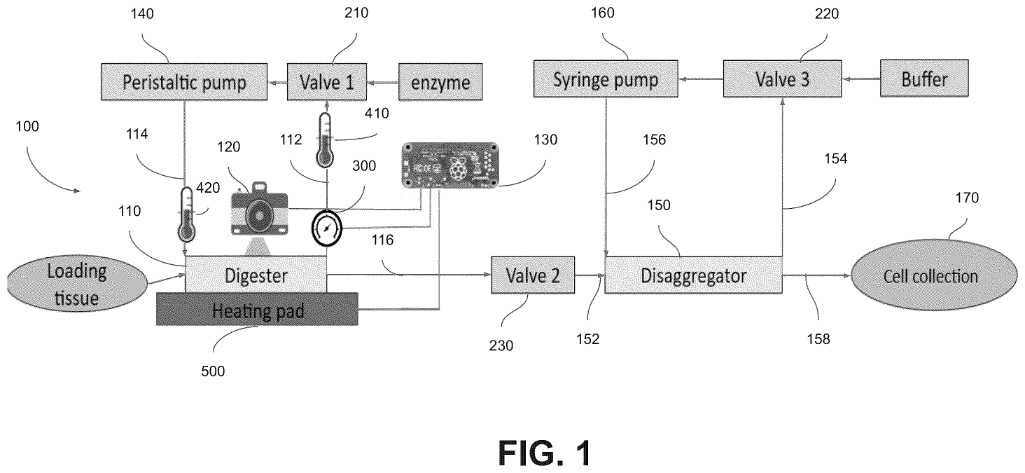

Referring now to FIG. 1, the present invention features a microfluidic system (100) for processing a tissue sample. The microfluidic system (100) may comprise a microfluidic digestion device (110) comprising an enzyme inlet (114), an enzyme outlet (112), a cell aggregate outlet (116), and a flow loop defined between the enzyme outlet (112), the enzyme inlet (114), and the cell aggregate outlet (116) the flow loop comprising a cell aggregate chamber configured to hold the tissue sample. The system (100) may further comprise a camera (120) visually coupled to an interior of the microfluidic digestion device (110), configured to generate a stream of data comprising visual data of the tissue sample within the interior of the microfluidic digestion device (110).

The system (100) may further comprise a computing device (130) communicatively coupled to the camera (120), comprising a processor capable of executing computer-readable instructions, and a memory component operatively coupled to the processor comprising computer-readable instructions. The computer-readable instructions may comprise accepting the stream of data from the camera (120) as a plurality of images, converting each image of the plurality of images into a Red-Blue-Green (RGB) format, identifying, for each image of the plurality of images, the tissue sample, calculating, for each image of the plurality of images, an area of the tissue sample, and calculating, for each image of the plurality of images, an intensity of a red value within the area of the tissue sample.

The system (100) may further comprise a first pump (140) fluidly coupled to the enzyme outlet (112) and the enzyme inlet (114) of the microfluidic digestion device (110), configured to circulate an enzyme-containing fluid through the microfluidic digestion device (110). In some embodiments, the enzyme-containing fluid may comprise collagenase I, collagenase IV, hyaluronidase, dispase, or a combination thereof. The system (100) may further comprise a microfluidic disaggregation device (150) comprising a cell aggregate inlet (152) fluidly coupled to the cell aggregate outlet (116) of the microfluidic digestion device (110), a buffer inlet (154), a buffer outlet (156), a cell aggregate outlet (158), and a flow loop defined between the cell aggregate inlet (152), the buffer inlet (154), the buffer outlet (156), and the cell aggregate outlet (158). The system (100) may further comprise a second pump (160) fluidly coupled to the buffer inlet (154) and the buffer outlet (156) of the microfluidic disaggregation device (150) configured to run the cell aggregate suspension through the microfluidic disaggregation device (150), and a collection chamber (170) fluidly coupled to the cell aggregate outlet (158) of the microfluidic disaggregation device (150).

In some embodiments, the system (100) may further comprise one or more valves (210) interposed between the enzyme inlet (114) and the enzyme outlet (112) of the microfluidic digestion device (110). In some embodiments, the system (100) may further comprise one or more valves (220) interposed between the buffer outlet (156) and the buffer inlet (154) of the microfluidic disaggregation device (150). In some embodiments, The microfluidic system (100) of claim 1, further comprising one or more valves (230) interposed between the cell aggregate outlet (116) of the microfluidic digestion device (110) and the cell aggregate inlet (152) of the microfluidic disaggregation device (150). In some embodiments, the camera (120) may be mounted above the microfluidic digestion device (110).

In some embodiments, the system (100) may further comprise one or more lighting fixtures disposed within the microfluidic digestion device (110), configured to minimize shadows and reflections within the microfluidic digestion device (110). In some embodiments, the system (100) may further comprise a pressure sensor (300) operatively coupled to the enzyme outlet (112) of the microfluidic digestion device (110) and the computing device (130), configured to measure a pressure value within the microfluidic digestion device (110).

In some embodiments, the system (100) may further comprise a first temperature sensor (410) operatively coupled to the enzyme outlet (112) of the microfluidic digestion device (110), and a second temperature sensor (420) operatively coupled to the enzyme inlet (114) of the microfluidic digestion device (110), each configured to measure a temperature of the tissue sample. The first temperature sensor (410) and the second temperature sensor (420) may be operatively coupled to the computing device (130). In some embodiments, the tissue sample may comprise a collection of cells from a tumor, a liver, a kidney, a heart, a spleen, or any sample of organic animal cells.

In some embodiments, the system (100) may further comprise a heating pad (500) operatively coupled to the microfluidic digestion device (110) and the computing device (130), configured to heat the interior of the microfluidic digestion device (110). The memory component may further comprise computer-readable instructions for accepting the temperature of the tissue sample from the first temperature sensor (410) and the second temperature sensor (420) and adjusting, by the heating pad (500), the temperature of the interior of the microfluidic digestion device (110) if the temperature of the tissue sample is below a minimum temperature or above a maximum temperature.

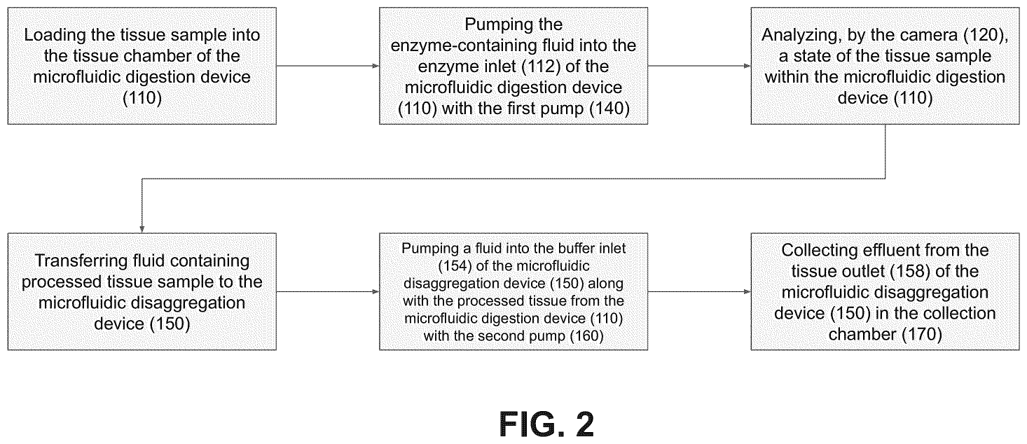

Referring now to FIG. 2, the present invention features a method of using the microfluidic system (100). The method may comprise loading the tissue sample into the tissue chamber of the microfluidic digestion device (110), pumping the enzyme-containing fluid into the enzyme inlet (114) of the microfluidic digestion device (110) with the first pump (140), analyzing, by the camera (120), a state of the tissue sample within the microfluidic digestion device (110), transferring fluid containing processed tissue sample to the microfluidic disaggregation device (150), pumping the processed tissue sample from the microfluidic digestion device (110) into the microfluidic disaggregation device (150) with the second pump (160), and collecting effluent from the single cell aggregate outlet (158) of the microfluidic disaggregation device (150) in the collection chamber (170). In some embodiments, pumping the enzyme-containing fluid into the enzyme outlet (112) of the microfluidic digestion device (110) with the first pump (140) comprises recirculating fluid into the microfluidic digestion device (110) with the first pump (140) through the enzyme inlet (114) and the enzyme outlet (112). In some embodiments, the processed tissue sample may comprise a cell aggregate.

The present invention features a microfluidic system (100) for processing a tissue sample. The system (100) may comprise a microfluidic digestion device (110) comprising an outlet (116), and a flow loop comprising a tissue chamber configured to hold the tissue sample. The system (100) may further comprise a camera (120) visually coupled to an interior of the microfluidic digestion device (110), configured to generate a stream of data comprising visual data of the tissue sample within the interior of the microfluidic digestion device (110). The system (100) may further comprise a computing device (130) communicatively coupled to the camera (120), comprising a processor capable of executing computer-readable instructions, and a memory component operatively coupled to the processor comprising computer-readable instructions for accepting the stream of data from the camera (120) as a plurality of images and calculating, for each image of the plurality of images, an intensity of a red value of the tissue sample. The system (100) may further comprise a microfluidic disaggregation device (150) comprising an inlet fluidly coupled to the outlet (116) of the microfluidic digestion device (110), an outlet, and a flow loop defined between the inlet of the microfluidic disaggregation device (150) and the outlet of the microfluidic disaggregation device (150), and a collection chamber (170) fluidly coupled to the outlet of the microfluidic disaggregation device (150).

In some embodiments, the camera (120) may be mounted above the microfluidic digestion device (110). In some embodiments, the system (100) may further comprise one or more lighting fixtures disposed within the microfluidic digestion device (110), configured to minimize shadows and reflections within the microfluidic digestion device (110). In some embodiments, the system (100) may further comprise a pressure sensor (300) operatively coupled to the outlet (116) of the microfluidic digestion device (110) and the computing device (130), configured to measure a pressure value within the microfluidic digestion device (110).

In some embodiments, the system (100) may further comprise a temperature sensor operatively coupled to the outlet (116) of the microfluidic digestion device (110), configured to measure the temperature of the tissue sample, wherein the temperature sensor is operatively coupled to the computing device (130). In some embodiments, the system (100) may further comprise a heating pad (500) operatively coupled to the microfluidic digestion device (110) and the computing device (130), configured to heat the interior of the microfluidic digestion device (110). The memory component may further comprise computer-readable instructions for accepting the temperature of the tissue sample from the temperature sensor and adjusting, by the heating pad (500), the temperature of the interior of the microfluidic digestion device (110) if the temperature of the tissue sample is below a minimum temperature or above a maximum temperature.

The computer system can include a desktop computer, a workstation computer, a laptop computer, a netbook computer, a tablet, a handheld computer (including a smartphone), a server, a supercomputer, a wearable computer (including a SmartWatchTM), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). The size of each pixel in data can range from 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer readable medium may be transmitted using any appropriate medium, including but not limited to wireless, wireline, optical fiber cable, R.F, Bluetooth, storage media, computer buses, etc., or any suitable combination of the foregoing. Computer program code for carrying out operations for aspects of the present disclosure may be written in any combination of one or more programming languages, including an object oriented programming language such as Java, Smalltalk, C#, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth, wherein the user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft®.NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64-bit architectures, or other architectural configurations now known or that may be developed in the future.

A processor typically executes an operating system, which may be, for example, a Windows-type operating system from the Microsoft® Corporation; the Mac OS X operating system from Apple Computer Corp.®; a Unix® or Linux®-type operating system available from many vendors or what is referred to as an open-source; another or a future operating system; or some combination thereof. An operating system interfaces with firmware and hardware in a well-known manner and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, communication control, and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of the medium. Combinations of media are also included within the scope of computer-readable media.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A microfluidic system (100) for processing a tissue sample comprising:
a. a microfluidic digestion device (110) comprising an enzyme inlet (110), an enzyme outlet (112), a cell aggregate outlet (116), and a flow loop defined between the enzyme outlet (112), the enzyme inlet (114), and the cell aggregate outlet (116) the flow loop comprising a cell aggregate chamber configured to hold the tissue sample;
b. a camera (120) visually coupled to an interior of the microfluidic digestion device (110), configured to generate a stream of data comprising visual data of the tissue sample within the interior of the microfluidic digestion device (110);
c. a computing device (130) communicatively coupled to the camera (120), comprising a processor capable of executing computer-readable instructions, and a memory component operatively coupled to the processor comprising computer-readable instructions for:
i. accepting the stream of data from the camera (120) as a plurality of images;
ii. converting each image of the plurality of images into a Red-Blue-Green (RGB) format;
iii. identifying, for each image of the plurality of images, a size and a red color intensity of the tissue sample;
iv. calculating, for each image of the plurality of images, an area of the tissue sample; and
v. calculating, for each image of the plurality of images, an intensity of a red value within the area of the tissue sample;
d. a first pump (140) fluidly coupled to the enzyme outlet (112) and the enzyme inlet (114) of the microfluidic digestion device (110), configured to circulate an enzyme-containing fluid through the microfluidic digestion device (110);
e. a microfluidic disaggregation device (150) comprising a cell aggregate inlet (152) fluidly coupled to the cell aggregate outlet (116) of the microfluidic digestion device (110), a buffer inlet (154), a buffer outlet (156), a cell aggregate outlet (158), and a flow loop defined between the cell aggregate inlet (152), the buffer inlet (154), the buffer outlet (156), and the cell aggregate outlet (158);
f. a second pump (160) fluidly coupled to the buffer inlet (154) and the buffer outlet (156) of the microfluidic disaggregation device (150) configured to run the tissue sample through the microfluidic disaggregation device (150); and
g. a collection chamber (170) fluidly coupled to the cell aggregate outlet (158) of the microfluidic disaggregation device (150).

2. The microfluidic system (100) of claim 1, further comprising one or more valves (210) interposed between the enzyme inlet (114) and the enzyme outlet (112) of the microfluidic digestion device (110).

3. The microfluidic system (100) of claim 1, further comprising one or more valves (220) interposed between the buffer outlet (156) and the buffer inlet (154) of the microfluidic disaggregation device (150).

4. The microfluidic system (100) of claim 1, further comprising one or more valves (230) interposed between the cell aggregate outlet (116) of the microfluidic digestion device (110) and the cell aggregate inlet (152) of the microfluidic disaggregation device (150).

5. The microfluidic system (100) of claim 1, wherein the camera (120) is mounted above the microfluidic digestion device (110).

6. The microfluidic system of claim 1 further comprising one or more lighting fixtures disposed within the microfluidic digestion device (110), configured to minimize shadows and reflections within the microfluidic digestion device (110).

7. The microfluidic system (100) of claim 1 further comprising a pressure sensor (300) operatively coupled to the enzyme outlet (112) of the microfluidic digestion device (110) and the computing device (130), configured to measure a pressure value within the microfluidic digestion device (110).

8. The microfluidic system (100) of claim 1 further comprising a first temperature sensor (410) operatively coupled to the enzyme outlet (112) of the microfluidic digestion device (110), and a second temperature sensor (420) operatively coupled to the enzyme inlet (114) of the microfluidic digestion device (110), each configured to measure a temperature of the tissue sample, wherein the first temperature sensor (410) and the second temperature sensor (420) are operatively coupled to the computing device (130).

9. The microfluidic system (100) of claim 8 further comprising a heating pad (500) operatively coupled to the microfluidic digestion device (110) and the computing device (130), configured to heat the interior of the microfluidic digestion device (110).

10. The microfluidic system (100) of claim 9, wherein the memory component further comprises computer-readable instructions for:
a. accepting the temperature of the tissue sample from the first temperature sensor (410) and the second temperature sensor (420); and
b. adjusting, by the heating pad (500), a temperature of the interior of the microfluidic digestion device (110) if the temperature of the tissue sample is below a minimum temperature or above a maximum temperature.

11. A method of using the microfluidic system (100) of claim 1 comprising:
a. loading the tissue sample into the tissue chamber of the microfluidic digestion device (110);
b. pumping the enzyme-containing fluid into the enzyme inlet (114) of the microfluidic digestion device (110) with the first pump (140);
c. analyzing, by the camera (120), a state of the tissue sample within the microfluidic digestion device (110);
d. transferring fluid containing a cell aggregate processed from the tissue sample to the microfluidic disaggregation device (150);
e. pumping the cell aggregate from the microfluidic digestion device (110) into the microfluidic disaggregation device (150) with the second pump (160); and
f. collecting effluent from the single cell aggregate outlet (158) of the microfluidic disaggregation device (150) in the collection chamber (170).

12. The method of claim 11, wherein pumping the enzyme-containing fluid into the enzyme outlet (112) of the microfluidic digestion device (110) with the first pump (140) comprises recirculating fluid into the microfluidic digestion device (110) with the first pump (140) through the enzyme inlet (114) and the enzyme outlet (112).

13. A microfluidic system (100) for processing a tissue sample comprising:
a. a microfluidic digestion device (110) comprising an outlet (116), and a flow loop comprising a tissue chamber configured to hold the tissue sample;
b. a camera (120) visually coupled to an interior of the microfluidic digestion device (110), configured to generate a stream of data comprising visual data of the tissue sample within the interior of the microfluidic digestion device (110);
c. a computing device (130) communicatively coupled to the camera (120), comprising a processor capable of executing computer-readable instructions, and a memory component operatively coupled to the processor comprising computer-readable instructions for:
i. accepting the stream of data from the camera (120) as a plurality of images; and
ii. calculating, for each image of the plurality of images, an intensity of a red value of the tissue sample;
d. a microfluidic disaggregation device (150) comprising an inlet fluidly coupled to the outlet (116) of the microfluidic digestion device (110), an outlet, and a flow loop defined between the inlet of the microfluidic disaggregation device (150) and the outlet of the microfluidic disaggregation device (150); and
e. a collection chamber (170) fluidly coupled to the outlet of the microfluidic disaggregation device (150).

14. The microfluidic system (100) of claim 13, wherein the camera (120) is mounted above the microfluidic digestion device (110).

15. The microfluidic system (100) of claim 13 further comprising one or more lighting fixtures disposed within the microfluidic digestion device (110), configured to minimize shadows and reflections within the microfluidic digestion device (110).

16. The microfluidic system (100) of claim 13 further comprising a pressure sensor (300) operatively coupled to the outlet (116) of the microfluidic digestion device (110) and the computing device (130), configured to measure a pressure value within the microfluidic digestion device (110).

17. The microfluidic system (100) of claim 13 further comprising a temperature sensor operatively coupled to the outlet (116) of the microfluidic digestion device (110), configured to measure a temperature of the tissue sample, wherein the temperature sensor is operatively coupled to the computing device (130).

18. The microfluidic system (100) of claim 17 further comprising a heating pad (500) operatively coupled to the microfluidic digestion device (110) and the computing device (130), configured to heat the interior of the microfluidic digestion device (110).

19. The microfluidic system (100) of claim 18, wherein the memory component further comprises computer-readable instructions for:
a. accepting the temperature of the tissue sample from the temperature sensor; and
b. adjusting, by the heating pad (500), a temperature of the interior of the microfluidic digestion device (110) if the temperature of the tissue sample is below a minimum temperature or above a maximum temperature.
